(19) United States
(12) Patent Application Publication
(10) Pub. No.: US 2013/0030935 A1
(43) Pub. Date: Jan. 31, 2013

(54) Method for distributing media content

(71) Applicants: Brian Tooks, Chicago, IL (US); Daryl Edwards, Olathe, KS (US)

(72) Inventors: Brian Tooks, Chicago, IL (US); Daryl Edwards, Olathe, KS (US)

(21) Appl. No.: 13/192,144

(22) Filed: Jul. 27, 2011

(51) Int. Cl. G06Q 30/00; G06Q 50/00

(52) U.S. Cl. 705/26.1

(57) ABSTRACT

A method for distributing media content in which a distribution platform within a telecommunications network is used to promote future content releases to consumers and to distribute the content to their remote terminals as streams or downloads, provided that consumers and/or advertisers aggregately commit enough revenue to meet a predetermined revenue target, the meeting of which is a prerequisite for distribution.

### BACKGROUND OF THE INVENTION

Historically, artists in the music industry had basically three ways to monetize their works: (a) sell physical copies of recordings (audio or video) of them to consumers via a multi-layered distribution network; (b) conduct and sell admission to live performances of them; and/or (c) command royalty payments for radio or television broadcasts of the live performances.

Unfortunately, the radio and television options were practically unavailable to artists who lacked media buzz or notable fanbases or who created works deemed unworthy for airplay for any of a variety of reasons. It is extremely difficult to make a viable business case that is predicated upon selling advertising time during the broadcast of a relatively unknown artist's performance, for example. Furthermore, the proposition of hosting a concert event that could fail to produce at least enough revenue to recoup investments in promotions, productions, facility rental and possible travel expenses was, and continues to be, an unattractive one for a great many artists and their promoters. Consequently, artists who may have possessed superstar talent, but never were fortunate enough to gain exposure to large audiences or have their recordings placed in a vast number of retail sites, usually were unable to realize great commercial success.

The advent of the Internet and other broadband telecommunications mediums changed that reality, to some extent, as it introduced a new world of commercial options for music creators. For example, the ability to transmit digital content files from one computing terminal to another reshaped the music distribution model and eliminated significant overhead cost components, such as the cost to transport physical recording units to retail stores. This has lowered retail costs to consumers and/or has improved profit margins for distributors. More importantly for unheralded artists, the combined abilities to inexpensively promote themselves with online modes of advertising and to send data files of their content to consumers located virtually anywhere via telecommunications networks has gained them exposure to large audiences far more efficiently than ever before possible.

That digital file transfer capability has also presented great challenges to modern artists, especially those in the music industry. More specifically, the ability of consumers to share can copy digital audio files without making payment to the authorized distribution chain a now illegal, but continuing practice—has tremendously drained revenue from artists. And with increased virtual retailer competition, even lawful downloading for which distributor-retailers are appropriately compensated has proven to be a considerably less lucrative revenue stream for the industry than was the business of selling units content recorded on physical mediums (e.g., compact discs). Consequently, the traditional live concert has returned to prominence as a significant, if not primary, means of generating income for many artists.

However, concerts are not a viable alternative for all artists. Typically, in order to schedule a concert, a promoter has to be willing to assume financial obligations of renting a facility, advertising the event, paying various productions costs, etc. If the artist has not yet demonstrated enough local commercial appeal to give a promoter confidence that its concert would be well-enough attended to recover those costs, not to mention produce an actual profit, then the promoter is unlikely to take the risk, and the concert is unlikely to occur. Thus, there is an outstanding need for a media distribution framework through which content owners can deliver both their recording products (e.g., audio and video file downloads) and their broadcast products (e.g., streaming audio and video) directly to consumers in a manner that ensures them of realizing at least some minimally acceptable revenue amounts. Furthermore, there is a need for such a framework to provide opportunity to increase revenue from and profitability of live performance events and, in some cases, to determine the feasibility of putting on such events prior to financial commitments to do so being made. The present method substantially fulfills these needs.

### SUMMARY OF THE INVENTION

The present invention generally relates to distribution of media content via a telecommunications network, and it is directed specifically to a method for increasing the demand, enlarging the paying audience, and collecting revenue for distribution of media content while mitigating financial risks currently associated with distributing content recordings or hosting live performances. In fact, the present method serves as a business model by which artists can deliver content to consumers and/or promoters can firmly arrange live performance events with degrees of profit certainty.

In its broadest sense, the invention is web-based media content distribution and revenue collection methodology in which content owners offer to publish content directly to consumer terminals, by way of data downloading or streaming, upon instances of multiple consumers and/or advertisers collectively committing to pay threshold amounts to acquire individual rights to receive the offered content and/or rights to display advertisements during transmission of the content. The present inventors anticipate this new methodology significantly changing the ways in which: (1) content is distributed and paid for; (2) the value of online-delivered content is perceived; (3) live performances are promoted; and (4) the facility requirements and financial risks of executing live performance events are assessed.

It is, therefore, a first object of the present invention to provide a networked platform that revolutionizes the conventional media distribution model by removing barriers to market entry for many artists. In one aspect of the invention, a content distributing entity provides a website from which virtually any aspiring artist or other content copyright owner (hereinafter, separately and together broadly referred to as an “artist-owner” entity) can deliver its content to consumer terminals, via the Internet and other telecommunications networks, upon a plurality of consumers contributing toward the fulfillment of a specified sales target prior to those deliveries. In another aspect, the artist-owner establishes a publishing account that is automatically credited with a predetermined share of the proceeds of each executed content sale, thus eliminating some of the layered licensing and royalty fee arrangements often existent in the conventional media distribution model and reducing the corresponding cost of distribution from the artist-owner's perspective. In the context of selling streaming video of live events, this aspect of the invention can also remove the traditional barrier of having to generate sufficient advertising revenue to facilitate a broadcast.

Nevertheless, it is an object of the invention to provide a business model that eliminates considerable uncertainty and risk for advertisers. Heretofore, advertising in television, radio and even online broadcasts mediums typically required a vendor to assume the risk of agreeing to pay an advertising fee that, in retrospect, could prove to be significantly greater than the actual viewership of the broadcast warranted, as a contemplating advertiser would have to rely upon historical data of viewership, traffic counts, etc. to inform an educated estimate of a future broadcasts' viewership. In contrast, under the present method, a contemplating broadcast sponsor would be guaranteed to have at least some specific minimum number of consumers exposed to its purchased advertisement and could, therefore, assess the financial prudence of advertising with greater certainty.

It is an object of the invention to provide an arrangement by which the artist-owner are guaranteed to receive at least a threshold amount of compensation prior to them first releasing content into the marketplace. In another aspect of the invention, the artist-owner publishes, on the website, both: (a) a planned content release date and (b) a total sales target (e.g., minimum total order count and/or dollar count) which must be reached by the planned release date as a prerequisite for the release actually occurring and the order requests being executed. Then, once the sales target has been reached, submitted order funds are automatically collected and deposited into the artist-owner's account (likely via an initial transfer and payment to the site publisher), and digital content files are, indeed, made downloadable beginning on the published release date. In addition, vendor advertising arrangements could be considered in determining whether a requisite of amount of fund commitments have been secured to warrant a planned content release or broadcast.

This threshold consumer commitment aspect of the invention enables the artist-owner to mitigate potential revenue losses due to unauthorized file transfers of their content from bona fide purchasers to non-paying third parties in away that was impossible prior to the present invention. More specifically, whereas, heretofore, a single digital recording file could be bought by one bone fide purchaser and, theoretically, could then be illegally duplicated and transferred to every other person in the world without any recompense to the artist-owner, using the present business method, at least some number of potential non-paying consumers—a specific number dictated by the artist-owner—would effectively be forced to confer payment to the artist-owner prior to the content being first released anywhere. This phenomenon of giving the artist-owner greater control over the promulgation and monetization of its content both improves the content sales revenue outlook for artist-owners at all echelons of the recording industry, and it enables them to increase the intrinsic value of the content itself. For example, an artist-owner could offer to release a limited number of file copies during a finite period and could, conceivably, command a significantly higher unit price than it could if releasing an indefinite number of copies.

It is an object of the invention to create a revenue stream for live performances that improves their profitability. For one, webcasting can essentially increase the audience capacity of the host venue for a live event to virtually infinite size and make the event accessible to a huge audience that, for geographic, transportation, venue seating capacity, seat pricing, personal comfort and various other reasons, are unlikely attend in-person. For another, online broadcasting increases revenue without commensurately increasing promotional or production costs. This dynamic potentially makes a concert performed in a high school gymnasium as profitable as one performed in a large civic arena, for example.

It is another object of the invention to provide a mechanism that can be strategically used to guarantee profitability of live events. To wit, an artist-owner can set an online access order deadline that is far enough in advance of a planned broadcast that, if its order target is not reached by the deadline, the artist-owner plausibly could cancel the event prior to having made certain unrecoverable expenditures.

It is another object of the invention to have all promoted and purchasable content categorized by artist, genre or other criteria, and for it to be searchable by those categories and by keywords. In that regard, it is another object to provide an environment in consumers' cross-interests can be gleaned by comparing their content searches and purchases. In fact, the greater the variety of content available for download or streaming, the more accurate a consumer profile can be formulated.

Finally, it is an object of the invention to be a distribution method that is generally applicable to a wide variety of media types, including, but not limited to, recorded music, musical performances, theatrical performances, motion pictures, television productions, short films, and sporting events.

### BRIEF DESCRIPTION OF THE DRAWINGS

FIG. 1 is a flow diagram illustrating the steps of a preferred embodiment of a method for distributing media content according to the present invention an embodiment in which content is distributed upon a predetermined revenue threshold being met;

FIG. 2 is a flow diagram illustrating the steps of an alternative embodiment of a method for distributing media content according to the present invention an embodiment in which content is distributed upon a proportionality ratio of revenue to content requests being met; and

FIG. 3 is a block diagram illustrating a system for distributing media content according to the method of the present invention.

### DETAILED DESCRIPTION OF THE PREFERRED EMBODIMENTS

This disclosure, as defined by the claims that follow and as illustrated, by way of example, in the accompanying drawings, generally relates to a method of distributing digital media content through a telecommunications network, and it is specifically directed to a method by which a content artist-owner uses a distribution platform to promote future releases of its content to consumers and then send the content to their remote terminals, via the network and by way of streaming or downloading, on the condition of receiving enough content purchase orders from those consumers and/or advertising orders to fulfill a specific revenue target set by the artist-owner or required by the distribution platform operator. The present inventors anticipate that this method will be used to monetize music content, primarily, and that it will be done so by both: (a) creating new, and in some cases sole, revenue streams from broadcasting live music events to remote consumer terminals; and (b) inspiring in consumers a sense of urgency to purchase streamed and downloadable music content that may be available exclusively from a single distribution source. Nevertheless, they recognize that the present method will likely be used to distribute a wide variety of media content types and not just that which concerns musical art.

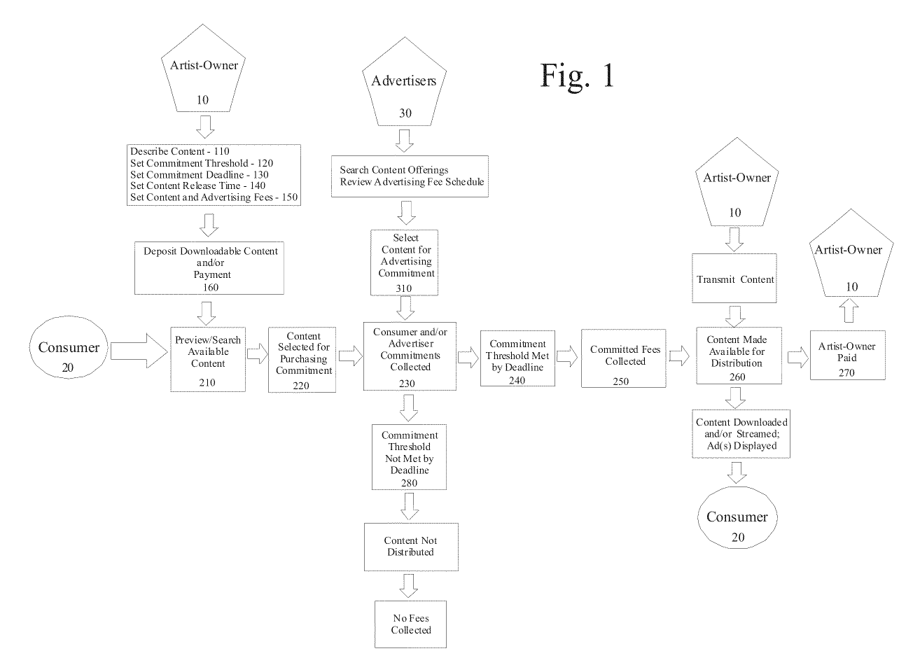

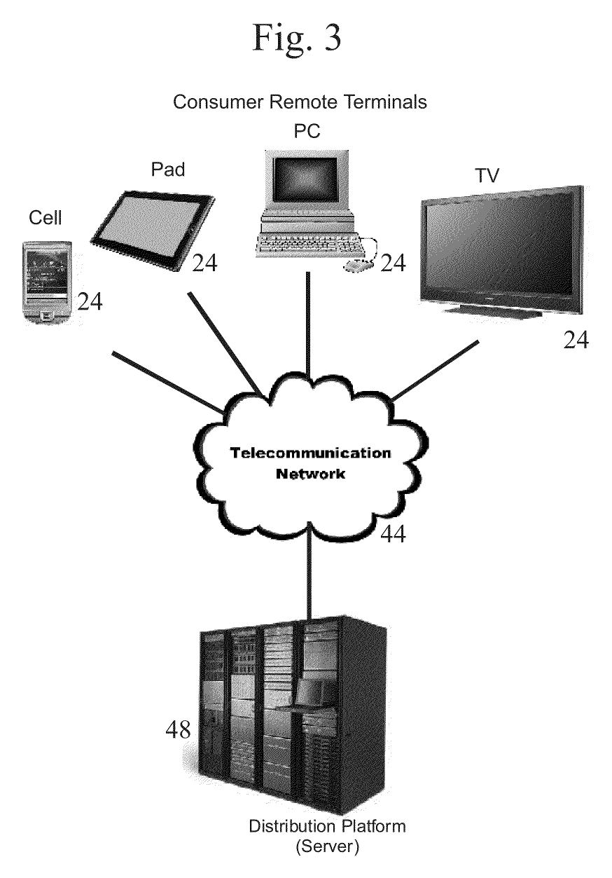

As indicated in FIGS. 1-3, the present method for distributing media content to consumers 20 involves interactions between at least three distinct entities: (1) an artist-owner 10 who creates the content or owns some copyright on it and who desires to distribute the content to the public 20 on the condition that it secures at least some specific target amount of compensation by some specific time point; (2) a distributor (not shown) who operates a content distribution platform that is accessible through a telecommunications network 44 and who may elect to actively promote the content to or more passively enable the artist-owner 10 to self-promote its content using that platform; and (3) end consumers 20 whom each access the platform in order to obtain a transferable file or broadcast stream of the content upon the artist-owner 10 achieving its compensation goal. Additionally, the process may incorporate a fourth entity: one or more advertisers 30. Advertisers 30 are provided the opportunity to have their still images shown within the display (e.g., a web browser) of the terminal 24 on which each consumer 20 views streaming content, and to have their videos and still images shown immediately before, and maybe even during, both streaming broadcasts and the file downloading process. Either the distributor or the artist-owner 10 can set advertising pricing, and those prices may vary depending on factors such as image/video size, selected time placement within a stream broadcast (e.g., immediately prior to the broadcast commencement vs. five minutes thereafter), and number of placement repetitions.

Whereas, a media content “distributor” has historically been defined as an entity owning rights to sell content, publish it, or otherwise make it available to consumers 20 (or owning the right to license those rights to others), for purposes of the present discussion, a “distributor” is merely an entity which operates a distribution platform where media content is made available to consumers 20 by way of a distribution method of the present invention. The distributor provides a virtual content marketplace which facilitates transactions between artist-owners 10 and consumers 20—as well as commercial advertisers 30, in some instances. It should be noted, however, that a distributor and an artist-owner 10 can be the same individual or business concern operating within the scope of this invention. In other words, the distribution platform could be owned and operated by an artist-owner 10 for the sole purpose of promoting and selling its own content creations exclusively. Nevertheless, the following discussion contemplates the distributor and artist-owner 10 being distinct entities and the distribution platform being used for selling works of multiple different artist-owners 10 who may have no affiliation with each other or the distributor.

As used in the present disclosure, the term “distribution platform” jointly refers to a server 48 (hereinafter, itself, referred to simply as a host “computer”) and a website stored thereon. The telecommunications network 44 through which the computer and website are accessed by consumers terminals 24 (e.g., personal computers, televisions, PDA's, wireless phones, etc.) will typically be the Internet, but it may be virtually any network 44 through which the host computer 48 can receive data from remote terminals 24 and send audio and data thereto. Finally, it is anticipated that artist-owners 10 and advertisers 30 will have some ability to affect what is viewed on the website, and the extent to which those parties 10, 30 may input or upload data directly without any screening by or intermediate act of the site-operating distributor can vary within the scope and spirit of the present invention. For example, in a preferred embodiment of the present method, the artist-owner 10 establishes a password-protected user account that allows it to enter and upload data to the distribution platform and to receive deposits of funds to which it may be entitled from payments made by consumers 20 or advertisers 30. The artist-owner's access to the distribution platform can be authorized either free of charge or by subscription or transaction fee arrangement. Similarly, a prospective advertiser 30 establishes a website account into which it may deposit funds and upload video and images which can serve as advertisements.

As depicted in FIG. 1, an iteration of the preferred embodiment of the present method is executed by, first, an artist-owner 10 inputting into the website several bits of information (steps 110-150) which should at least include the following: (1) a description of a future event to be broadcasted on the website or of previously recorded content to be downloaded from the website (step 110); (2) a total committed revenue amount which must be generated from consumer requests for the content, advertising commitments or both as a precondition for the content to become accessible to consumers 20 (step 120); (3) a future time, or deadline, by which that precondition must be met (step 130); (4) a future time at which the content will become downloadable or begin streaming if the precondition is met (step 140); (5) a consumer distribution fee amount (step 150), if applicable; and (6) an advertising fee schedule (step 150), if applicable. Additionally, the website should prompt the artist-owner 10 to identify whether its content offering is to be of a closed-end or open-end type. In a closed-end offer, distribution is limited to a predetermined number of consumers that is at least equal to the number of paying consumers 20 which may be needed to attain the revenue threshold. An artist-owner 10 may prefer this option for the reason that it increases the fair value of each content file or broadcast transmitted. In an open-end offer, content may be distributable to an indefinite number of consumers 20 and for an indefinite period of time so long as the artist-owner's revenue target is achieved by its pre-set deadline. In any event, the website should present an artist-owner 10 with a host of standard data entry fields and selection menus to directly provide these inputs.

Where the content is in the form of an existing digital file that wilt be distributed to consumers 20 via downloading or podcasting, for example, it is anticipated that the artist-owner 10 will be required to upload the content file to the distribution platform (step 160) prior to its aforementioned data entries being published on the website. This kind of security deposit forecloses the possibility of consumers 20 going through the exercise of requesting content and expecting to receive it when, in fact, the content ultimately proves undeliverable. Conversely, where the content is to be in the form of a live stream broadcast, it is anticipated that the artist-owner 10 will be required to make a monetary deposit (step 160) that could mitigate any reputational harm sustained by the distributor as result of the broadcast not taking place through no fault of its own. Additionally, the website may provide software and accompanying instructions which enable the artist-owner 10 to use its own camera and video equipment to deliver images and sound from a live event to the distribution platform for streaming to consumer terminals 24. However, it is alternatively contemplated that the distributor and artist-owner 10 might coordinate such arrangements “off-line.” For instance, as an ancillary service, the distributor could provide and on-site camera crew to capture and broadcast an artist-owner's event.

Referring back to FIG. 1, after the artist-owner 10 inputs all the terms and choices associated with a content offer (steps 110-150), at least some of the inputted information becomes viewable as a content offering on the website, and offer data is appropriately organized for consumer consumption. In fact, for user friendliness purposes, information that enables consumers 20 to search for content offerings (step 210) using various search criteria (e.g., performing artists, copyright owner, genre, creation date, release date, title, concert venue location or other general descriptions) should be stored in a database on the server. In preferred embodiments, consumers 20 are permitted free, uninhibited access to browse published content offerings (step 210). However, to actually register an executable request for content, a consumer 20 must, first, establish a site user account which allows the distribution platform to associate his or her website activity to a specific user identity. Establishing a consumer account should entail submitting personal information (e.g., name, email address, etc.) and corresponding financial account information (e.g., credit/debit account number, card expiration date, associated mailing address, PIN, etc.). It is anticipated that distributors will employ mechanisms well-known in the art for tracking and analyzing consumer search and transaction activities on the website. This kind of information can help the distributor to analyze consumer habits and to alert consumers 20 to upcoming content offerings that might appeal to their individual tastes. And if provided to potential advertisers 30, it can help them to efficiently choose content offerings to associate their advertisements to.

As shown in FIG. 1, in a preferred embodiment of the present method, once an entered content offering is published on the website, a consumer 20 may participate in the offering by simultaneously registering a request to receive download or stream access to the content upon its planned release time and authorizing a corresponding debit to be made against its registered financial account (step 220) should the artist-owner's threshold revenue goal be achieved and, therefore, that access be granted. However, in an alternative embodiment, consumers 20 are not required to pay content distribution fees and, instead, advertising sales must account for all of the sought revenue. Nevertheless, whatever the nature of the revenue stream is, when the set deadline by which consumers 20 must submit their content requests is reached, the host computer 48 will compare the total amount of then committed consumer payments and/or advertiser payments with the revenue threshold previously set by the author-owner 10 to determine whether the revenue requirement has been satisfied. In addition, the host software may apply an algorithm for determining whether any portions of consumer-paid subscription fees should be counted toward satisfying the revenue goal of a particular offering.

If the revenue threshold is determined to have been achieved (step 240), the content will be made available for distribution to all requesting consumers 20, committed fees will be automatically collected from the financial accounts of participating consumers 20 and advertisers 30 (step 250), and a share of all collected funds will be automatically paid to the artist-owner 10 (step 270) according to a compensation arrangement previously entered into by the artist-owner 10 and distributor. On the other hand, if the revenue threshold is not reached by the deadline (step 280), none of the committed funds are collected from consumers 20 or advertisers 30, and the content is not released to the consumers 20 that requested it.

For example, in a closed-end offering in which consumers 20 will pay to download content, the planned release time might be on Monday August 1st, and interested consumers might have until Sunday, July 31st to register requests to download content files and authorize corresponding debits (e.g., ten dollars) against their financial accounts (step 220) in exchange for those downloading privileges. Accordingly, upon arriving at the Sunday request deadline, the distributor's host computer 48 will determine whether the sum of consumer payments committed is at least equal to the revenue threshold previously set by the author-owner 10. If it is (step 240), committed consumers 20 will be permitted to download the content to their terminals 24 (step 260) beginning at the Monday planned release time—typically, by the distributor emailing to each committed consumer 20 a unique password for initiating the download in question—and the artist-owner's account will be appropriately credited with earned compensation (step 270). However, if the threshold is not met (step 280), none of the committed distribution fees are seized from consumer accounts, and the content is not released as planned. It should be noted that virtually identical steps are executed in a content offering in which the artist-owner's revenue requirement may be satisfied by a combination of consumer and advertiser payment commitments.

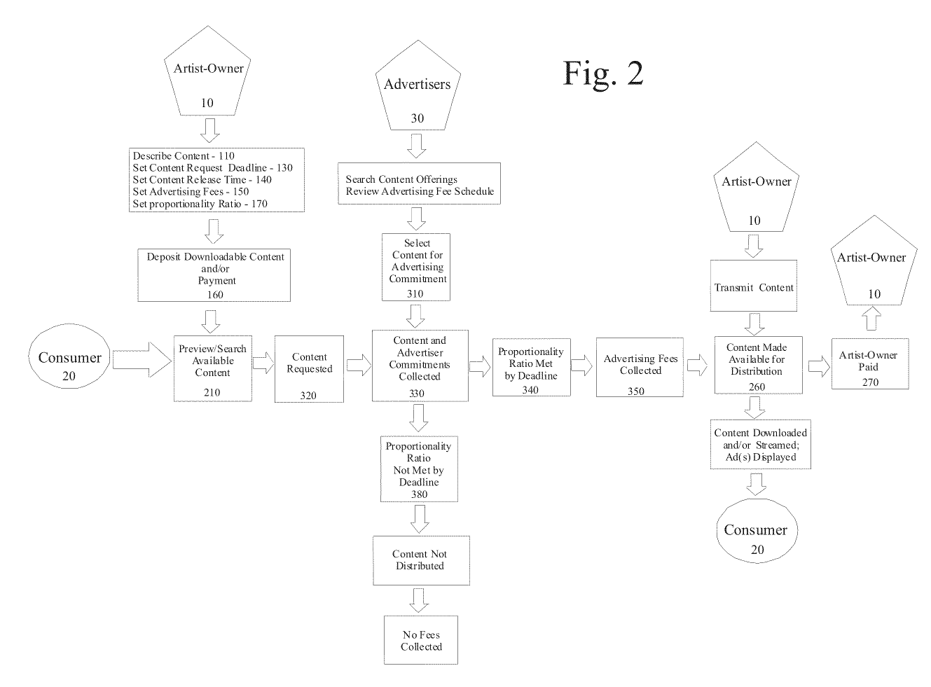

FIG. 2 illustrates an alternative embodiment of the present invention and embodiment in which consumers 20 can access content free of charge provided that a content offering generates advertising revenue in some mandated proportion to the number of consumers who formally request to receive the free content. In this context, a required proportionality value is defined according to a proportionality ratio calculated by applying a coefficient mandated by the distribution platform or set the artist-owner 10 (step 170) and communicated to prospective advertisers 30 at the outset of the of the offering. For example, if the artist-owner's required consumer request-to-advertising revenue ratio is 10-to-1 and exactly 100,000 consumers 20 request to receive its free content, then at least $10,000 worth of advertising commitments must be secured and pending in order to trigger the free content release. In other words, the requisite proportional value of committed advertising revenue equals [the number of logged requests for content] multiplied by [a coefficient of 0.10].

In an iteration of this alternative embodiment of the present method, a consumer 20 needs simply to visit the website and formally request to access the content (step 320). There is no financial commitment associated with such a request. So, for example, in a closed-end offering in which consumers 20 are to receive a streaming broadcast of a live concert free of charge, consumers 20 are required to simply register their requests (step 320) to view the stream prior to a request deadline (e.g., by Sunday, July 30. Advertisers 30 will also have a deadline (which may be on or sometime after the consumer request deadline) by which to commit to specific advertising purchase arrangements (step 310). Then, upon expiration of the advertising purchase deadline, the distribution platform's host computer 48 compares the number of pending consumer requests with the sum of any advertising payments committed to determine whether the artist-owner's set proportionality requirement has been satisfied, as explained above. If it has been (step 340), timely requesting consumers 20 who are logged into their website accounts will be able to view the stream on their terminals 24 (step 260), committed finds are seized from advertiser accounts (step 350), and compensation is paid to the artist-owner 10 that published the offering (step 270). Of course, if the total advertising commitment is not at least proportional to the consumer request count (step 380), then the concert is not streamed on the website, the contingent advertising purchase agreements are not consummated, and no funds are paid to the artist-owner's account.

It is understood that substitutions and equivalents for and combinations of various elements set forth above may be obvious to those skilled in the art and may not represent a departure from the spirit of the invention. Therefore, the full scope and definition of the present invention is to be set forth by the claims that follow.

1. (canceled)

2. (canceled)

3. (canceled)

4. A method for distributing media content from a server to remote terminals via a telecommunications network on the condition that the content becomes distributable only if a predetermined amount of commitments to later pay for the content are sent from remote terminals to the server by a predetermined time, the method comprising:
displaying, by the server via the network, an offer to distribute the content upon the condition of the server receiving, from remote terminals by the predetermined time, the predetermined amount of future payment commitments, wherein those making future payment commitments by the predetermined time are defined as committers;
receiving, at the server, future payment commitments sent to it from remote terminals by committers; and
distributing the content, by the server to remote terminals via the network, provided that total future payment commitments received from committers meet or exceed a predetermined threshold value.

5. The method of claim 4, further comprising collecting payments from committers, provided that total future payment commitments received, by the server from committers, meet or exceed the threshold value.

6. The method of claim 4, wherein said threshold value is a currency value that is greater than the currency value of at least one future payment commitment received from a committer.

7. The method of claim 4, wherein distributing comprises the server streaming data representing the content, via the network, to terminals associated with committers.

8. The method of claim 4, wherein said telecommunications network comprises at least one of: the Internet, a telephone network, a satellite broadcast network, and a cable network.

9. The method of claim 4, wherein said payment commitments comprise commitments to pay, in the future, for content on an itemized basis.

10. The method of claim 9, wherein said payment commitments further comprise commitments to pay, in the future, for content on a subscription basis.

11. The method of claim 9, wherein said payment commitments further comprise commitments to pay in the future for advertising.

12. The method of claim 4, wherein displaying comprises the server transmitting to third party terminals data representing publishing fee information, the predetermined time, and at least one of: a time at which said content will begin being distributable, a description of said content, a publication title for said content, and identification of an artist associated with said content.

13. The method of claim 4, wherein a payment commitment comprises a submission of information that enables its recipient to collect funds from a financial account.

14. The method of claim 4, wherein a payment commitment comprises a submission of an indication of intent to pay it recipient.

15. The method of claim 4, wherein distributing comprises enabling third parties to stream data representing said content from the server to their terminals.

16. The method of claim 4, wherein distributing comprises enabling third parties to download digital files representing said content from the server to their terminals.

17. A method for distributing media content via a telecommunications network using a computer having software stored thereupon, the method being embedded in the software and comprising:
displaying, via the network, an offer to distribute the content upon (i) receiving, by a predetermined time, at least two requests for the content and (ii) receiving at least one payment commitment which, in total, meets or exceeds a proportional value, wherein the proportional value is defined as the product of (i) the number of content requests received by the predetermined time and (ii) a predetermined coefficient;
receiving, by the predetermined time, at least two content requests via the network;
receiving at least one payment commitment; and
distributing the content, via the network, provided that total payment commitments received meet or exceed the proportional value.

18. The method of claim 17, further comprising collecting payments provided that total payment commitments received meet or exceed the proportional value.

19. The method of claim 17, wherein said payment commitments comprise commitments to pay for advertising.

20. The method of claim 17, wherein distributing comprises enabling the content to be received by only those having requested it, via the network, by the predetermined time.

21. The method of claim 4, wherein distributing comprises the server sending, via the network, digital files representing the content to terminals associated with committers.

22. A method for distributing media content stored in a database of a server to remote terminals via a telecommunications network on the condition that the content becomes distributable only if a predetermined amount of commitments to later pay for the content are sent from remote terminals to the server by a predetermined time, the method comprising:
displaying, by the server via the network, an offer to distribute the content upon the condition of the server receiving, from remote terminals by the predetermined time, the predetermined amount of future payment commitments, wherein those making future payment commitments by the predetermined time are defined as committers;
receiving, at the server, payment commitments sent to it from remote terminals by committers; and
distributing the content, by the server to remote terminals via the network, provided that total future payment commitments received from committers meet or exceed a predetermined threshold value.

23. The method of claim 22, wherein distributing comprises the server sending, via the network, digital files representing the content to terminals associated with committers.

24. The method of claim 22, wherein distributing comprises enabling third parties to download digital files representing the content from the server to their terminals.
